(19) United States
(12) Patent Application Publication
(10) Pub. No.: US 2009/0021631 A1
(43) Pub. Date: Jan. 22, 2009

(54) IMAGE CAPTURING DEVICE AND AUTO-FOCUS METHOD FOR SAME

(75) Inventor: YI-TA CHIANG-LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/940,907

(22) Filed: Nov. 15, 2007

(30) Foreign Application Priority Data
Jul. 17, 2007 (CN) 200710201101.5

(51) Int. Cl. H04N 5/232

(52) U.S. Cl. 348/345; 348/E05.042; 348/E05.045; 348/E05.047

(57) ABSTRACT

An image capturing device includes a taking lens, an image sensor for capturing images of an object, an auto-focus unit for focusing the image capturing device, and an input device configured for inputting a command to capture an image by users. The auto-focus unit includes an image processing unit, a comparing unit, and a taking lens driving unit. The image processing unit is configured for comparing definition of the images to judge a clearest image therefrom, and gaining the in-focus position of the taking lens. The comparing unit is configured for judging whether the object is moved after the image processing unit gaining an in-focus position and gaining a new in-focus position if the object have been moved. The taking lens driving unit is configured for moving the taking lens to the in-focus position.

### TECHNICAL FIELD

The present invention relates to an image capturing device and auto-focus method for the same and, particularly, to an image capturing device and auto-focus method for raising auto-focus accuracy.

### DESCRIPTION OF RELATED ART

With the development of optical imaging technology, image capturing devices are widely used in electronic devices, such as digital cameras and mobile phones. At present, most of the image capturing devices have auto-focus functions.

In an auto-focus process of a typical auto-focus image capturing device, a taking lens of the image capturing device is moved to many positions in order to detect an in-focus position. When the taking lens is at the in-focus position, the image capturing device can capture an image of an object clearly. But in many instances, there will be some time lag from when the image capturing device is focused to user pressing a button to capture an image. During the time lag, the object focused on may move and be out of focus in the captured image.

What is needed, therefore, is an image capturing device which can solve the above problem and can focus accurately.

### SUMMARY

In accordance with one present embodiment, an image capturing device includes a taking lens, an image sensor for capturing images of an object, an auto-focus unit for focusing the image capturing device, and an input device configured for inputting a command to capture an image by users. The auto-focus unit includes an image processing unit, a comparing unit, and a taking lens driving unit. The image processing unit is configured for comparing definition of the images to judge a clearest image therefrom, and gaining the in-focus position of the taking lens. The comparing unit is configured for judging whether object focused on have moved after the image processing unit has gained an in-focus position and gaining a new in-focus position if objects have moved. The taking lens driving unit is configured for moving the taking lens to the in-focus position. An auto-focus method is also presented.

### BRIEF DESCRIPTION OF THE DRAWING

Many aspects of the present image capturing device can be better understood with reference to the following drawings. The components in the drawing are not necessarily drawn to scale, the emphasis instead being placed upon clearly illustrating the principles of the present image capturing device. Moreover, in the drawings, like reference numerals designate corresponding parts throughout the several views.

FIG. 1 is a schematic, functional block diagram of an image capturing device according to a present embodiment.

FIG. 2 is a schematic, functional block diagram of an auto-focus unit of the image capturing device of FIG. 1.

FIG. 3 is a flow chart of an auto-focus method of the image capturing device of FIG. 1.

### DETAILED DESCRIPTION OF THE EMBODIMENTS

Embodiments will now be described in detail below, with reference to the drawings.

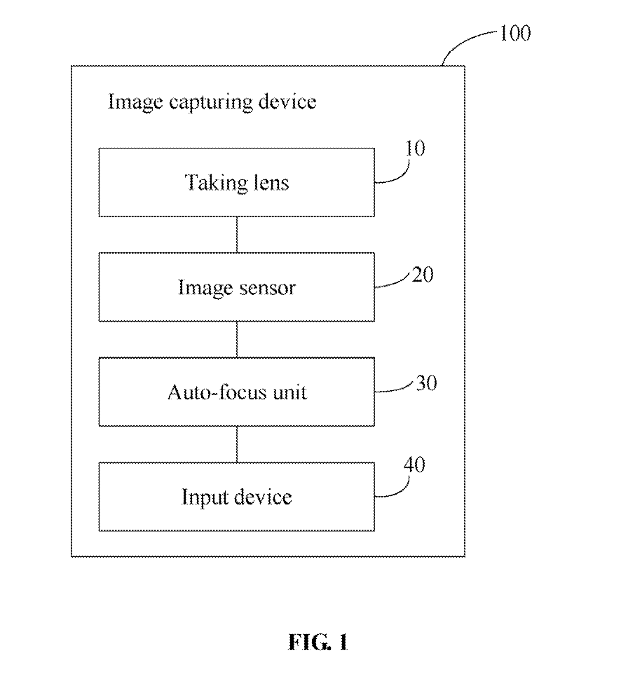

Referring to FIG. 1, an image capturing device 100, according to an embodiment, is shown. The image capturing device 100 includes a taking lens 10, an image sensor 20, an auto-focus unit 30, and an input device 40. The image capturing device 100 can be a digital camera, a video camera, or a mobile phone with image capturing function.

The taking lens 10 can include many lenses capable of being divided into several lens groups. The taking lens 10 can be a zoom lens or a lens with fixed focal length.

The image sensor 20 is configured for converting light transmitted through the taking lens 10 to digital electrical signals. The image sensor 20 can be a charge-coupled device (CCD) or a complementary metal oxide semiconductor device (CMOS). The image sensor 20 can further be selected from a group consisting of a ceramic leaded chip carrier (CLCC) package type image sensor, a plastic leaded chip carrier (PLCC) package type image sensor, and a chip scale package (CSP) type image sensor.

The input device 40 is configured for inputting a command to capture an image by users. The image capturing device 100 will capture an image immediately after a command to capture an image is input.

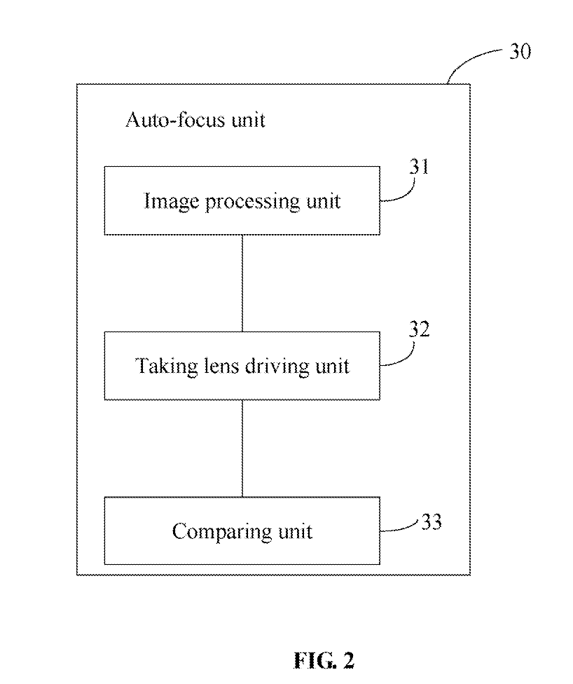

Referring to FIG. 2, the auto-focus unit 30 is configured for focusing the image capturing device 100. The auto-focus unit 30 can determine an in-focus position for the taking lens 10 and drive the taking lens 10 to the in-focus position. The auto-focus unit 30 includes an image processing unit 31, a taking lens driving unit 32, and a comparing unit 33.

The image processing unit 31 receives the electrical signals converted by the image sensor 20 and can get definition information of each image represented by the electrical signals. In a focusing process of the image capturing device 100, the taking lens 10 has to be moved to a number of positions and the image sensor 20 senses images at each of the positions. The image processing unit 31 compares the definition of these images in order to select the clearest image and position the taking lens 10 corresponding to the position the clearest image was obtained, named as in-focus position. The definition information includes many kinds of data, such as for contrast, grayscale, and/or intensity. In order to shorten the focusing process of the image capturing device 100, the image processing unit 31 can compare the definition of the images using only one kind of definition information.

The comparing unit 33 is configured for judging whether the object focused on have moved after the image processing unit 31 gaining an in-focus position and gaining a new in-focus position if the object have moved. Concretely, the comparing unit 33 can compare definition of an image sensed by the image sensor after gaining an in-focus position with the definition of the image corresponding to the in-focus position. If the definition of the image has degraded beyond a preset value relative to the image corresponding to the in-focus position, the image capturing device 100 will activate a routine to perform the focusing process again to gain a new in-focus position of the taking lens 10. In order that the image capturing device 100 can focus accurately when capturing the image of the object, preferably, the comparing unit 33 performs the judging process many times during the time from the image capturing device 100 gaining the in-focus position of the taking lens 10 to inputting a command to capture an image by users. In the present embodiment the judging process can be performed ten times per second.

The taking lens driving unit 32 is configured for moving the taking lens 10 during focusing processes of the image capturing device 100.

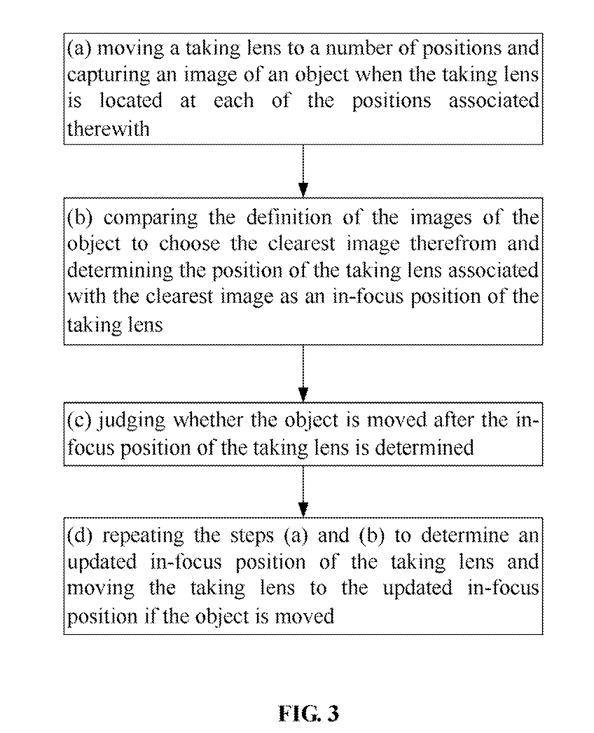

Referring to FIG. 3, an auto-focus method of the image capturing device 100 is also provided. The method includes the steps of: (a) moving a taking lens 10 to a number of positions and capturing an image of an object when the taking lens 10 is located at each of the positions associated therewith; (b) comparing the definition of the images of the object to choose the clearest image therefrom and determining the position of the taking lens 10 associated with the clearest image as an in-focus position of the taking lens 10; (c) judging whether the object is moved after the in-focus position of the taking lens 10 is determined; and (d) repeating the steps (a) and (b) to determine an updated in-focus position of the taking lens 10 and moving the taking lens 10 to the updated in-focus position if the object is moved.

The definition information includes many kinds of data, such as for contrast, grayscale, and/or intensity. In order to shorten the focusing process, the definition of the images are compared using only one kind of definition information. In step (c), if the definition of an image captured after the in-focus position is determined by the image sensor is less than the definition of the clearest image corresponding to the in-focus position, the object is regarded as having been moved after the in-focus position is determined. The process of judging whether the object have moved can be performed many times during the time from the image capturing device 100 gaining the in-focus position for the taking lens 10 to receiving a command to capture an image. Preferably, the process of judging whether the object is moved is performed ten times per second.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
a taking lens, an image sensor for capturing images, an auto-focus unit for focusing the image capturing device, and an input device configured for inputting a command to capture an image by users, the auto-focus unit comprising:
an image processing unit for comparing definition of the images to judge a clearest image therefrom, and gaining the in-focus position of the taking lens;
a comparing unit configured for judging whether the object is moved after the image processing unit gaining an in-focus position and gaining a new in-focus position if the object have been moved; and
a taking lens driving unit configured for moving the taking lens to the in-focus position.

2. The image capturing device as claimed in claim 1, wherein the image capturing device is selected from a group consisting of a digital camera, a video camera, and a mobile phone.

3. The image capturing device as claimed in claim 1, wherein the image sensor is selected from one of a charge-coupled device and a complementary metal oxide semiconductor device.

4. The image capturing device as claimed in claim 1, wherein the image sensor is selected from a group consisting of a ceramic leaded chip carrier package type image sensor, a plastic leaded chip carrier package type image sensor, and a chip scale package type image sensor.

5. The image capturing device as claimed in claim 1, wherein the image processing unit compares the definition of the images according to the definition information of the images, the definition information is selected from a group consisting of contrast information, grayscale information, and intensity information.

6. The image capturing device as claimed in claim 1, wherein the image processing unit compares the definition of the images using one kind of definition information of the images.

7. The image capturing device as claimed in claim 1, wherein the comparing unit judges whether the object is moved by comparing definition of an image sensed by the image sensor after gaining an in-focus position with the definition of the image corresponding to the in-focus position.

8. The image capturing device as claimed in claim 1, wherein the comparing unit performs the judging process of judging whether the object is moved a plurality of times during the time from the image capturing device gaining the in-focus position of the taking lens to inputting a command to capture an image by users.

9. The image capturing device as claimed in claim 8, wherein the judging process is performed ten times per second.

10. An auto-focus method of an image capturing device comprising the steps of:
(a) moving a taking lens to a number of positions and capturing an image of an object when the taking lens is located at each of the positions associated therewith;
(b) comparing the definition of the images of the object to choose the clearest image therefrom and determining the position of the taking lens associated with the clearest image as an in-focus position of the taking lens;
(c) judging whether the object is moved after the in-focus position of the taking lens is determined; and
(d) repeating the steps (a) and (b) to determine an updated in-focus position of the taking lens and moving the taking lens to the updated in-focus position if the object is moved.

11. The method as claimed in claim 10, wherein in step (c), if the definition of an image captured after the in-focus position is determined by the image sensor is less than the definition of the clearest image corresponding to the in-focus position, the object is regarded as having been moved after the in-focus position is determined.

12. The method as claimed in claim 10, wherein the step of judging whether the object is moved is performed ten times per second.

13. The method as claimed in claim 10, wherein the image processing unit compares the definition of the images according to the definition information of the images, the definition information is selected from a group consisting of contrast information, grayscale information, and intensity information.

14. An image capturing device comprising:
a taking lens movable relative to the image sensor at a plurality of positions;
an image sensor for capturing an image of an object when the taking lens is located at each of the positions;
an image processing unit for comparing the definition of the images to chose a clearest image therefrom and determining the position associated with the clearest image as an in-focus position of the taking lens;
a taking lens driving unit for moving the taking lens to the in-focus position; and
a comparing unit for comparing the definition of an image captured after the in-focus position is determined with that of the clearest image so as to judge whether the object is moved after the in-focus position is determined, and determining an updated in-focus position of the taking lens if the object is moved after the in-focus position is determined.
